(19) United States
(12) Patent Application Publication
(10) Pub. No.: US 2024/0319018 A1
(43) Pub. Date: Sep. 26, 2024

(54) Thermally Responsive Element And Manufacturing Method For The Same

(71) Applicant: UCHIYA THERMOSTAT CO., LTD., Saitama (JP)

(72) Inventor: Kazuyuki Iizuka, Saitama (JP)

(21) Appl. No.: 18/578,831

(22) PCT Filed: Jul. 20, 2022
(86) PCT No.: PCT/JP2022/028148

§ 371 Date: Jan. 12, 2024

(30) Foreign Application Priority Data
Jul. 21, 2021 (JP) 2021-120699

(51) Int. Cl. G01K 5/68

(52) U.S. Cl. CPC G01K 5/68

(57) ABSTRACT

A thermally responsive element in which the degree of freedom in setting a differential is high across a wide range of temperature zones and a relatively small differential is settable is provided. The element may be a plate-like member having a shape that changes in accordance with a temperature change. A cross-section of the thermally responsive element at room temperature may have a compound curved shape. A cross-section of the thermally responsive element after the shape change may have a compound curved shape. A border between the central portion and the outer peripheral portion is the same before and after the shape change of the thermally responsive element.

### TECHNICAL FIELD

The present invention relates to a thermally responsive element used in a temperature switch such as a thermostat and to a manufacturing method therefor.

### BACKGROUND ART

In a defrost heater mounted on a refrigerator and equipment used in cold regions, or an anti-freezing heater installed in a water pipe, manufacturing equipment of a chemical plant, and the like, a temperature switch such as a thermostat is used to prevent overheating and for controlling temperature. In freeze prevention of a water pipe, a temperature switch that starts supplying electricity to a heater at 3° C. and stops supplying electricity to the heater at 10° C., for example, is used. A temperature switch that can control the temperature of a freezer between −30° C. and −20° C. and a temperature switch that can control the temperature of a heater between 90° C. to 100° C. are increasingly required for industrial and commercial uses.

When a bimetal is used as a thermally responsive element of such temperature switches, a differential needs to be relatively small.

In Patent Document 1, it is described that a bimetal in which a warping temperature and a return temperature can be freely adjusted and the temperature range is from about-30° C. to about 200° C., can be manufactured.

In Patent Document 2, a bimetal disc in which a temperature difference (differential) between warping and reversion is small is described. The bimetal disc is formed in a rimmed dish shape by bending a flat-plate-like bimetal disc at a position spaced apart from the center by a certain distance across the entire periphery and forming the cross-sectional shape to be a straight line for both a central portion and a peripheral portion. It is described that operation at a temperature lower than room temperature becomes possible by bending the bimetal disc to the low expansion side.

In Patent Document 3, a disc-type bimetal characterized in that the surface area is increased by adding a concavity and a convexity to at least one surface of a region on which a bulging process is performed is described. It is described that the inversion temperature and the return temperature are low, and a temperature difference between the inversion temperature and the return temperature is small in the disc-type bimetal.

### CITATION LIST

### Patent Document

[Patent Document 1] Japanese Patent Laid-Open No. 63-16285
[Patent Document 2] Japanese Patent Laid-Open No. 58-198788
[Patent Document 3] Japanese Patent Publication No. 48-10429

### SUMMARY OF INVENTION

### Technical Problem

It is known that the operating temperature and the return temperature of a bimetal are strongly related to the shape of the bimetal when the bimetal is used as a thermally responsive element. However, in Patent Document 1, only a spherical shape is described, and a specific method for freely setting the temperature in various temperature zones is not indicated. In Patent Document 2, it is described that a bimetal that operates at a temperature lower than room temperature can be obtained, but a specific method and a specific operating temperature are not described. The process of concave and convex surfaces in Patent Document 3 is thought to be complicated.

Thus, an object of the present invention is to provide a thermally responsive element in which the degree of freedom in setting a differential is high across a wide range of temperature zones from a low temperature zone that falls below room temperature to a high temperature zone exceeding 100° C. and a relatively small differential is settable.

### Solution to Problem

In a thermally responsive element that is a plate-like member and has a shape that changes in accordance with a temperature change according to an aspect of the present invention, a cross-section of the thermally responsive element at room temperature has a compound curved shape formed by combining a plurality of curves, a cross-section of a central portion of the thermally responsive element and a cross-section of an outer peripheral portion surrounding the central portion each having a different curved shape. The shape of the thermally responsive element changes when a predetermined temperature out of the range of room temperature is reached, a cross-section of the thermally responsive element after the shape change has a compound curved shape formed by combining a plurality of curves, a cross-section of the central portion of the thermally responsive element and a cross-section of the outer peripheral portion surrounding the central portion each having a different curved shape, and a border between the central portion and the outer peripheral portion is the same before and after the shape change of the thermally responsive element.

### Advantageous Effects of Invention

According to the present invention, it is possible to provide the thermally responsive element in which the degree of freedom in setting the differential is high across a wide range of temperature zones from the low temperature zone that falls below room temperature to the high temperature zone exceeding 100° C., and the relatively small differential is settable.

### BRIEF DESCRIPTION OF DRAWINGS

FIG. 1 is a plan view of a thermally responsive element according to a first embodiment.

FIG. 2 is a cross-sectional view of FIG. 1 taken along line A-A′.

FIG. 3 is a cross-sectional view of the thermally responsive element after inversion.

FIG. 4A is an explanatory view showing a first step of a method of manufacturing the thermally responsive element.

FIG. 4B is an explanatory view showing a second step of the process of manufacturing the thermally responsive element.

FIG. 5A is an explanatory view showing a first step of another method of manufacturing the thermally responsive element.

FIG. 5B is an explanatory view showing a second step of the other method of manufacturing the thermally responsive element.

FIG. 6 is a perspective view of a punch used in the second step.

FIG. 7 is a cross-sectional view in the second step.

FIG. 8 is a plan view of a thermally responsive element according to a second embodiment.

FIG. 9 is a cross-sectional view of FIG. 8 taken along line B-B′.

FIG. 10 is a cross-sectional view of the thermally responsive element after inversion.

FIG. 11A is an explanatory view showing a first step of a method of manufacturing the thermally responsive element.

FIG. 11B is an explanatory view showing a second step of the process of manufacturing the thermally responsive element.

FIG. 12A is an explanatory view showing a first step of another method of manufacturing the thermally responsive element.

FIG. 12B is an explanatory view showing a second step of the other method of manufacturing the thermally responsive element.

FIG. 13A is a plan view of a thermally responsive element according to a third embodiment.

FIG. 13B is another plan view of the thermally responsive element according to the third embodiment.

FIG. 13C is yet another plan view of the thermally responsive element according to the third embodiment.

FIG. 14A is a plan view of a thermally responsive element according to a fourth embodiment.

FIG. 14B is another plan view of the thermally responsive element according to the fourth embodiment.

FIG. 14C is yet another plan view of the thermally responsive element according to the fourth embodiment.

FIG. 15 is a plan view of a thermally responsive element according to a fifth embodiment.

### DESCRIPTION OF EMBODIMENTS

The present invention is described below based on illustrated embodiments. However, the present invention is not limited to the embodiments described below. The dimensional ratios of the shapes shown in the drawings may not be the actual dimensional ratios. The dimensional ratios may be changed to describe the shapes in an easy-to-understand manner.

In the present specification, “room temperature” (or “normal temperature”) means a temperature that is 18° C. or more and 38° C. or less.

### First Embodiment

### Configuration

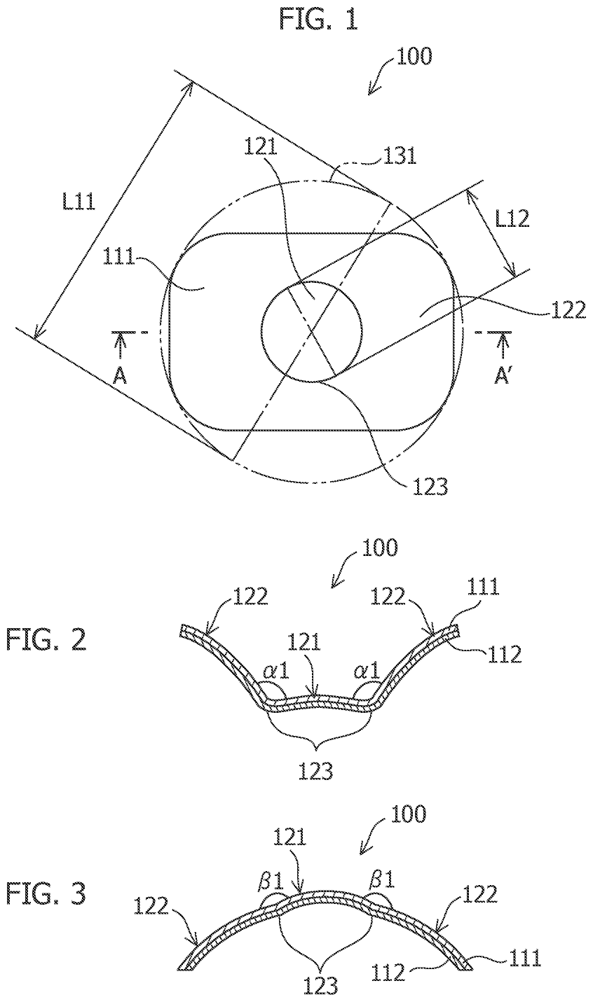

FIG. 1 is a plan view of a bimetal 100 that is a thermally responsive element according to the present embodiment. FIG. 2 is a cross-sectional view of FIG. 1 taken along line A-A′. Both drawings show the shape of the bimetal 100, which is shaped by a multi-stage pressing process using a punch and a die, at room temperature.

As shown in FIG. 1 and FIG. 2, the bimetal 100 is a plate-like member and has a low expansion layer 111, and a high expansion layer 112 positioned below the low expansion layer. The coefficient of thermal expansion of the material of the high expansion layer 112 is greater than that of the material of the low expansion layer 111.

The bimetal 100 has a central portion 121, an outer peripheral portion 122 surrounding the central portion, and a border 123 between the central portion 121 and the outer peripheral portion 122. The bimetal 100 has a concave shape in which the central portion 121 is depressed when viewed from above and has a convex shape in which the central portion 121 is protruding when viewed from below. It can be said that the bimetal 100 has a rimmed dish shape. An angle α1 formed by the central portion 121 and the outer peripheral portion 122 is an obtuse angle. The cross-sectional structure of the bimetal 100 has a compound curved shape formed by combining a plurality of curves. Specifically, the cross-sectional structure of the central portion 121 has a curved shape that is convex upward, and the cross-sectional structure of the outer peripheral portion 122 on both sides of the central portion 121 also has a curved shape that is convex upward. In the central portion 121 and each outer peripheral portion 122, the curvature radius of each of the curves may be the same or different.

In planar view, the central portion 121 has a circular shape, and the outer peripheral portion 122 has a rounded quadrilateral shape.

The border 123 is on a circumference of a concentric circle having a diameter length L12 that is 1% to 50% of a diameter length L11 of a circumcircle 131 circumscribed to the outer peripheral portion 122. However, the diameter length L12 of the concentric circle is smaller than the width of the rounded quadrilateral shape described above.

As the material of the bimetal 100, a Ni—Fe alloy can be used for the low expansion layer 111 and a Cu—Ni—Mn alloy can be used for the high expansion layer 112, for example. The length, the width, the shape of the angle, and the plate thickness of the rounded quadrilateral shape described above may be freely set in accordance with a target inversion temperature.

When the temperature of the bimetal decreases and becomes equal to or less than a predetermined temperature (return temperature) lower than room temperature, the bimetal is inverted by a snap action and changes from the shape shown in FIG. 2 to the shape shown in FIG. 3. The bimetal 100 after inversion has a convex shape in which the central portion 121 is protruding when viewed from above and has a concave shape in which the central portion 121 is depressed when viewed from below.

The shape after inversion is a compound curve formed by combining a plurality of curves. The border 123 between the central portion 121 and the outer peripheral portion 122 does not change before and after the inversion.

In FIG. 3, the cross-sectional structure of the central portion 121 has a curved shape that is convex upward, and the cross-sectional structure of the outer peripheral portion 122 on both sides of the central portion 121 also has a curved shape that is convex upward. The curvature radius of each of the curves may be the same or different.

An angle β1 formed by the central portion 121 and the outer peripheral portion 122 in FIG. 3 is an obtuse angle greater than the angle α1.

Due to the feature in which the angle β1 is greater than the angle α1 and the central portion 121 and both of the outer peripheral portions 122 each continue to have a curved shape that is convex upward before and after the inversion, a relatively small differential that is about 10 degrees can also be set. As shown in FIG. 2, the central portion 121 and each outer peripheral portion 122 have a shape (a curved shape that is convex upward) curved toward the same direction (inner side), and hence setting of a return temperature that is extremely low becomes possible.

When the temperature of the bimetal rises and becomes equal to or greater than a predetermined temperature (operating temperature) lower than room temperature, the bimetal is inverted by a snap action and returns to the shape shown in FIG. 2 from the shape shown in FIG. 3. This operating temperature is a temperature that is higher than the return temperature described above.

In the compound curve, a border portion between a certain curve and another curve may be rounded or angular.

A feature of a cross-section taken along a straight line that is parallel to the longitudinal direction of the bimetal and passes through the center of the circumcircle has been described as the cross-section, but a cross-section of a freely selected straight line that passes through the center also has a similar feature.

In FIG. 2, the shape, at room temperature, obtained by a multi-stage pressing process using the punch and the die has been described. However, a bimetal obtained by performing thermal processing after the shaping by the pressing process also has a similar feature in terms of the shape at room temperature.

### Manufacturing Method

A method of manufacturing the bimetal 100 includes a step of cutting a bimetal material configured by two types of metal layers of which coefficients of thermal expansion are different from each other into a freely selected shape, and a step of shaping the bimetal material after the cutting into the bimetal 100 by a multi-stage pressing process using a press machine. The multi-stage pressing process is performed in a state in which the bimetal material and tools including a punch and a die are in a state of being maintained at a temperature (18° C. or more and 38° C. or less) in the same range as room temperature. However, the multi-stage pressing process may be performed after cooling or heating the bimetal material and the tools. The punch is made of metal and has alloy tool steel and the like used therein. The die is made of an elastic material.

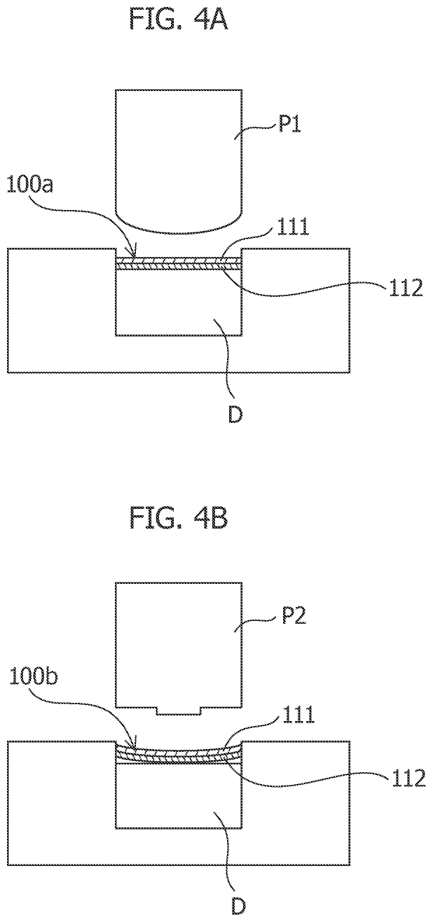

FIG. 4A shows a first step of performing a pressing process of a bimetal material 100a after the cutting. The bimetal material 100a after the cutting is disposed on a die D having a planar surface. At this time, the bimetal material 100a is disposed such that the low expansion layer 111 is on the side of a punch P1 made of metal and the high expansion layer 112 is on the side of the die D. The punch P1 having an end surface that is a convex surface is lowered, and the bimetal material 100a is pressed. By the first step as above, a bimetal material 100b (FIG. 4B) is obtained.

FIG. 4B shows a second step (a pressing step of the last stage) of further pressing the bimetal material 100b shaped by the first step. The bimetal material 100b obtained by the first step is disposed on the die D having a planar surface. At this time, the bimetal material 100b is disposed such that the low expansion layer 111 is on the side of a punch P2 made of metal and the high expansion layer 112 is on the side of the die D. The punch P2 having an end surface with a protruding portion formed thereon is lowered, and the bimetal material 100b is pressed. By the second step as above, the bimetal 100 shown in FIG. 1 and FIG. 2 is obtained.

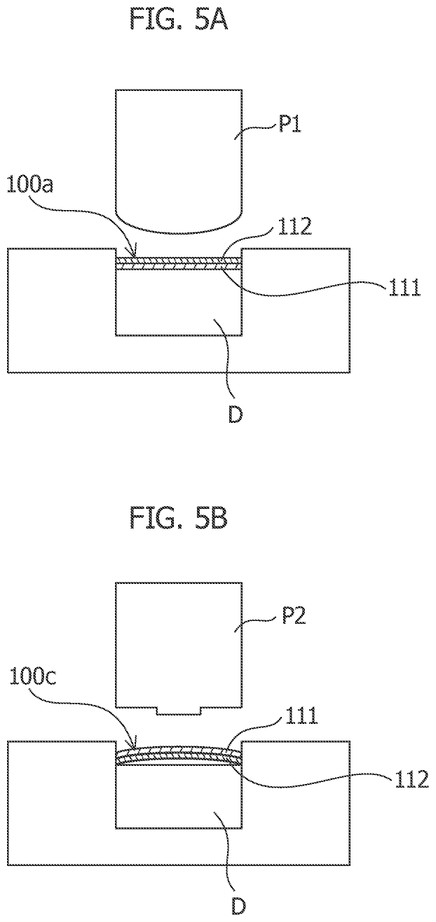

As shown in FIG. 5A, in the first step, when the bimetal material 100a after the cutting is disposed on the die D, the bimetal material 100a may be disposed such that the high expansion layer 112 is on the side of the punch P1 and the low expansion layer 111 is on the side of the die D. As above, the arrangement may be opposite from the arrangement of the bimetal material 100a shown in FIG. 4A. A bimetal material 100c (FIG. 5B) is obtained by the first step.

In the second step shown in FIG. 5B, as in FIG. 4B, a pressing process is performed by disposing the bimetal material 100c such that the low expansion layer 111 is on the side of the punch P2 and the high expansion layer 112 is on the side of the die D.

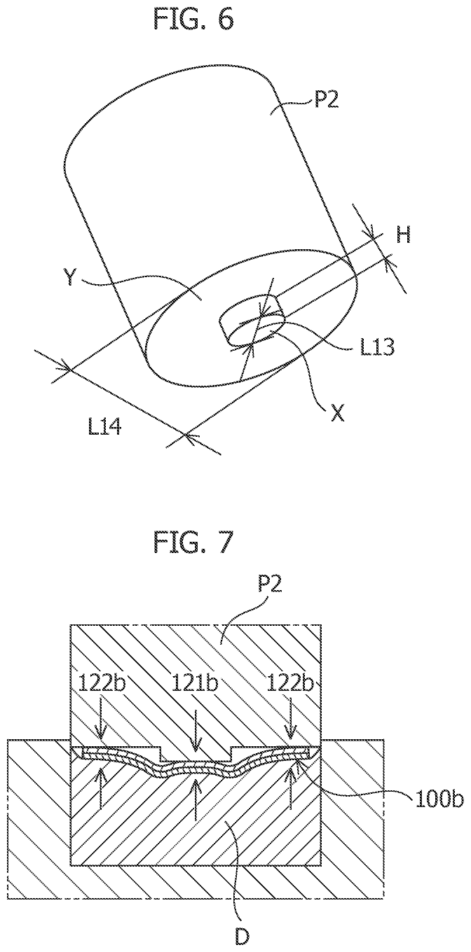

As shown in FIG. 6, a protruding portion X having a substantially columnar shape is formed in substantially the center of an end surface Y of the punch P2 having a substantially columnar shape. A diameter length L13 of the protruding portion X is 1% to 50% of the diameter length L11 of the circumcircle 131 circumscribed around the rounded quadrilateral shape described above. A protruding amount H of the protruding portion X from the end surface Y is 0.05 mm to 1 mm. An end surface of the protruding portion X and the end surface Y therearound may be a planar surface or a dish shape (dent shape). However, it is preferred that a diameter length L14 of the end surface Y be equal to or greater than the diameter length L11 of the circumcircle 131.

The end surface Y is not limited to a circular shape and can also be an oval shape or a quadrilateral shape (not shown).

With reference to FIG. 7, an effect of the second step (the pressing step of the last stage) using the punch P2 and the die D made of an elastic material is described. When the bimetal material 100b (or the bimetal material 100c) that has been subjected to the first step is disposed on the die D and the punch P2 is caused to descend, a central portion 121b and an outer peripheral portion 122b of the bimetal material 100b are sandwiched between the punch P2 and the die D and are fixed. When pressing is performed by the punch P2, a compound curved cross-sectional shape described above is formed due to the push back from the die D made of an elastic body. Unlike the related-art, a high degree of processing that cannot be obtained by simply performing pressing by a punch having a simple curved surface is given to the periphery of the border 123. As a result, an operating temperature and a return temperature that are extremely low or extremely high, and a relatively small differential that is about 10 degrees, can also be set.

In FIG. 7, the manufacturing method by the punch made of metal and the die made of an elastic material has been shown, but the present invention is not limited thereto. After the external form of the bimetal material is processed, the bimetal material may be sandwiched and pressed by upper and lower tools which are made of metal and which have a curved shape that fits the target curved shape of the bimetal. Thermal processing of one hour, for example, at a temperature from 50° C. to 300° C. is applied to the bimetal material after the pressing process.

### Effects

In the manufacturing method, the material (the composition, the plate thickness, and the temperature) of the bimetal, the shape after cutting, the pressing (the force, the time, and the temperature) in each of the first step and the second step, the end surface shape of the punch P1, the end surface shape (the diameter lengths L13 and L14 and the protruding amount H) of the punch P2, and the quality of material of the die are selected, as appropriate. As a result, an operating temperature lower than room temperature can be set, and the return temperature can be freely set. A relatively small differential that is about 10 degrees can also be set. The operating temperature, the return temperature, and the differential can also be adjusted by changing the shape of the end surface of the punch P1 in the first step.

When the diameter length L12 of the central portion 121 is less than 1% of the diameter length L11 of the circumcircle 131, the adjustment effect of the differential is thought to be small. When the diameter length L12 of the central portion 121 exceeds 50% of the diameter length L11, it is thought that the bimetal is hardly inverted by a snap action, and the height after inversion is low even when the bimetal is inverted. In other words, it is thought to not be preferable in terms of usage in a temperature switch and the like (cannot be effectively used in opening and closing of an electrical contact).

### Second Embodiment

### Configuration

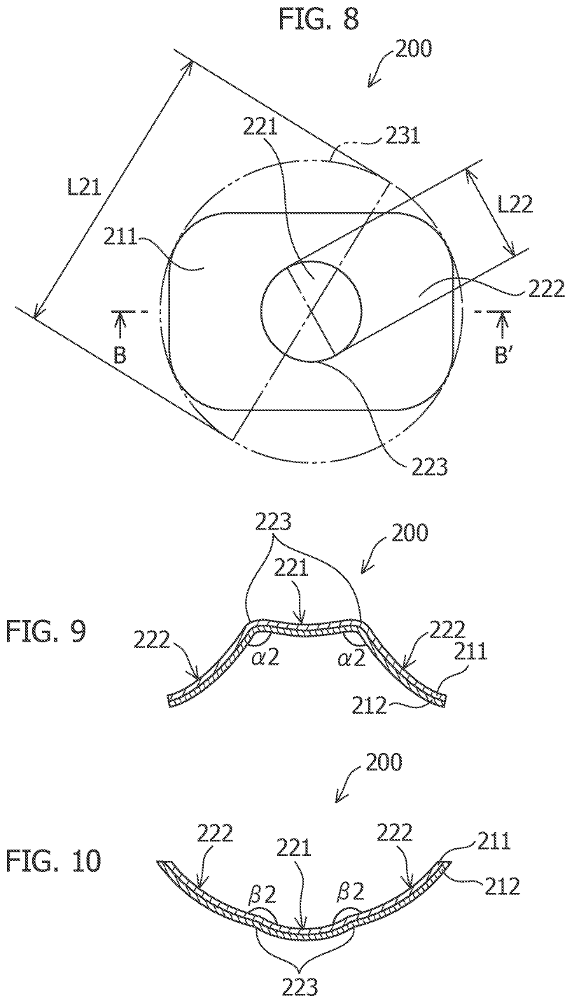

FIG. 8 is a plan view of a bimetal 200 that is a thermally responsive element according to the present embodiment. FIG. 9 is a cross-sectional view of FIG. 8 taken along line B-B′. Both drawings show the shape of the bimetal 200, which is shaped by a multi-stage pressing process using a punch and a die, at room temperature.

As shown in FIG. 8 and FIG. 9, the bimetal 200 is a plate-like member and has a low expansion layer 211, and a high expansion layer 212 positioned below the low expansion layer. The coefficient of thermal expansion of the material of the high expansion layer 212 is greater than that of the material of the low expansion layer 211.

The bimetal 200 has a central portion 221, an outer peripheral portion 222 surrounding the central portion, and a border 223 between the central portion 221 and the outer peripheral portion 222. The bimetal 200 has a convex shape in which the central portion 221 is protruding when viewed from above and has a concave shape in which the central portion 221 is depressed when viewed from below. It can be said that the bimetal 200 has a rimmed dish shape. An angle «2 formed by the central portion 221 and the outer peripheral portion 222 is an obtuse angle. The cross-sectional structure of the bimetal 200 has a compound curved shape formed by combining a plurality of curves. Specifically, the cross-sectional structure of the central portion 221 has a curved shape that is convex downward, and the cross-sectional structure of the outer peripheral portion 222 on both sides of the central portion 221 also has a curved shape that is convex downward. In the central portion 221 and each outer peripheral portion 222, the curvature radius of each of the curves may be the same or different. In plan view, the central portion 221 has a circular shape, and the outer peripheral portion 222 has a rounded quadrilateral shape.

The border 223 is on a circumference of a concentric circle having a diameter length L22 that is 1% to 50% of a diameter length L21 of a circumcircle 231 circumscribed to the outer peripheral portion 222. However, the diameter length L22 of the concentric circle is smaller than the width of the rounded quadrilateral shape described above.

As the material of the bimetal 200, a Ni—Fe alloy can be used for the low expansion layer 211 and a Cu—Ni—Mn alloy can be used for the high expansion layer 212, for example. The length, the width, the shape of the angle, and the plate thickness of the rounded quadrilateral shape described above are freely set in accordance with a target inversion temperature.

When the temperature of the bimetal increases and becomes equal to or greater than a predetermined temperature (operating temperature) higher than room temperature, the bimetal is inverted by a snap action and changes to the shape shown in FIG. 10 from the shape shown in FIG. 9. The bimetal 200 after the inversion has a concave shape in which the central portion 221 is depressed when viewed from above and has a convex shape in which the central portion 221 is protruding when viewed from below.

The shape after inversion is a compound curve formed by combining a plurality of curves. The border 223 between the central portion 221 and the outer peripheral portion 222 does not change before and after the inversion.

In FIG. 10, the cross-sectional structure of the central portion 221 has a curved shape that is convex downward, and the cross-sectional structure of the outer peripheral portion 222 on both sides of the central portion 221 also has a curved shape that is convex downward. The curvature radius of each of the curves may be the same or different.

In FIG. 10, an angle β2 formed by the central portion 221 and the outer peripheral portion 222 in FIG. 10 is an obtuse angle greater than the angle α2.

Due to the feature in which the angle β2 is greater than the angle α2 and the central portion 221 and both of the outer peripheral portions 222 each continue to have a curved shape that is convex downward before and after the inversion, a relatively small differential that is about 10 degrees can also be set. As shown in FIG. 9, the central portion 221 and each outer peripheral portion 222 have a shape (a curved shape that is convex downward) curved toward the same direction (inner side), and hence setting of an operating temperature that is extremely high becomes possible.

When the temperature of the bimetal decreases and becomes equal to or less than a predetermined temperature (return temperature), the bimetal is inverted by a snap action and returns to the shape shown in FIG. 9 from the shape shown in FIG. 10. The return temperature is a temperature that is lower than the operating temperature described above. In the compound curve, a border portion between a certain curve and another curve may be rounded or angular.

A feature of a cross-section taken along a straight line that is parallel to the longitudinal direction of the bimetal and passes through the center of the circumcircle has been described as the cross-section, but a cross-section of a freely selected straight line that passes through the center also has a similar feature.

In FIG. 9, the shape, at room temperature, obtained by a multi-stage pressing process using the punch and the die has been described. However, a bimetal obtained by performing thermal processing after the shaping by the pressing process also has a similar feature in terms of the shape at room temperature.

### Manufacturing Method

A method of manufacturing the thermally responsive element 200 according to the embodiment is substantially the same as the method of manufacturing the thermally responsive element 100 according to the first embodiment. However, the bimetal material is pressed from the low expansion layer side in the second step of the method of manufacturing the thermally responsive element 100, but the bimetal material is pressed from the high expansion layer side in the second step of the method of manufacturing the thermally responsive element 200.

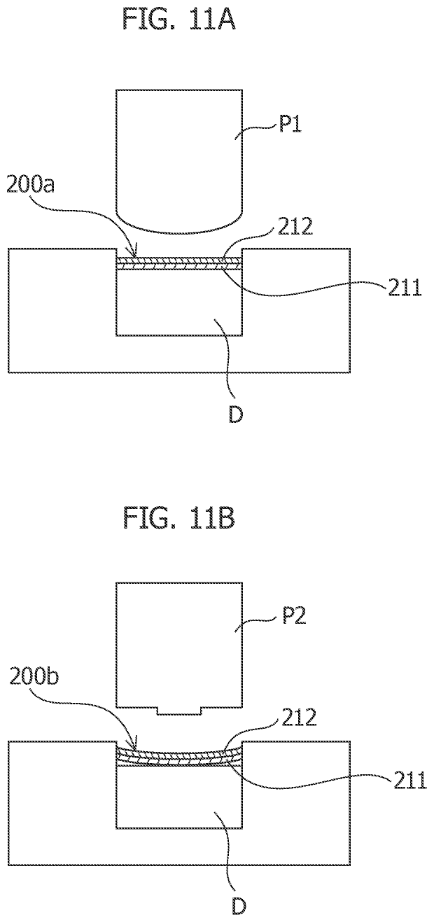

FIG. 11A shows a first step of performing a pressing process of a bimetal material 200a after the cutting. The bimetal material 200a after the cutting is disposed on the die D having a planar surface. At this time, the bimetal material 200a is disposed such that the high expansion layer 212 is on the side of the punch P1 and the low expansion layer 211 is on the side of the die D. The punch P1 having an end surface that is a convex surface is lowered, and the bimetal material 200a is pressed. By the first step as above, a bimetal material 200b (FIG. 11B) is obtained.

FIG. 11B shows a second step (a pressing step of the last stage) of further pressing the bimetal material 200b obtained by the first step. The bimetal material 200b obtained by the first step is disposed on the die D having a planar surface. At this time, the bimetal material 200b is disposed such that the high expansion layer 212 is on the side of the punch P2 and the low expansion layer 211 is on the side of the die D. The punch P2 having an end surface with a protruding portion formed thereon is lowered, and the bimetal material 200b is pressed. By the second step as above, the bimetal 200 shown in FIG. 8 and FIG. 9 is obtained.

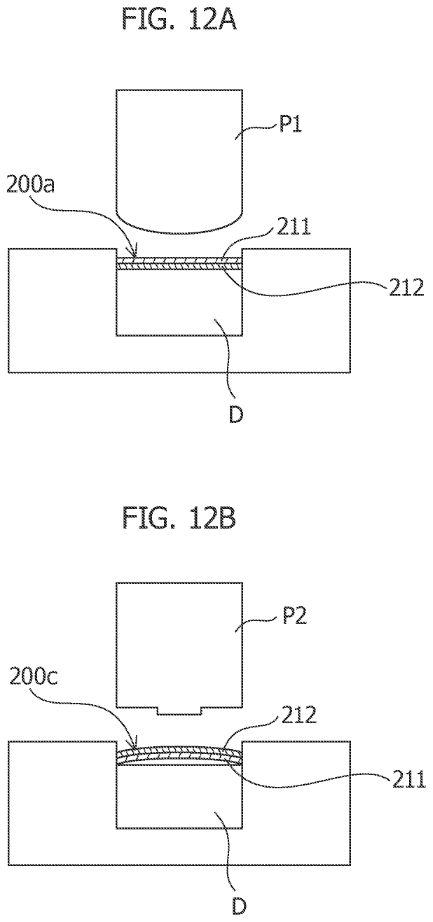

As shown in FIG. 12A, in the first step, when the bimetal material 200a after the cutting is disposed on the die D, the bimetal material 200a may be disposed such that the low expansion layer 211 is on the side of the punch P1 and the high expansion layer 212 is on the side of the die D. As above, the arrangement may be opposite from the arrangement of the bimetal material 200a shown in FIG. 11A. A bimetal material 200c (FIG. 11B) is obtained by the first step.

In the second step shown in FIG. 12B, as with FIG. 11B, a pressing process is performed by disposing the bimetal material 100c such that the high expansion layer 212 is on the side of the punch P2 and the low expansion layer 211 is the die D.

The punches P1 and P2 are made of metal and have alloy tool steel and the like used therein. The die D is made of an elastic material. Thermal processing of one hour, for example, at a temperature from 100° C. to 500° C., is applied to the processed bimetal.

### Effects

In the manufacturing method, the material (the composition, the plate thickness, and the temperature) of the bimetal, the shape after cutting, the pressing (the force, the time, and the temperature) in each of the first step and the second step, the end surface shape of the punch P1, the end surface shape (the diameter lengths L13 and L14 and the protruding amount H) of the punch P2, and the quality of material of the die are selected, as appropriate. As a result, an operating temperature higher than room temperature can be set, and the return temperature can be freely set. A relatively small differential that is about 10 degrees can also be set. The operating temperature, the return temperature, and the differential can also be adjusted by changing the shape of the end surface of the punch P1 in the first step.

When the diameter length L22 of the central portion 221 is less than 1% of the diameter length L21 of the circumcircle 231, the adjustment effect of the differential is thought to be small. When the diameter length L22 of the central portion 221 exceeds 50% of the diameter length L21, it is thought that the bimetal is hardly inverted by a snap action, and the height after inversion is low even when the bimetal is inverted. In other words, it is thought to not be preferable in terms of being used in a temperature switch and the like (cannot be effectively used in opening and closing of an electrical contact).

### Third Embodiment

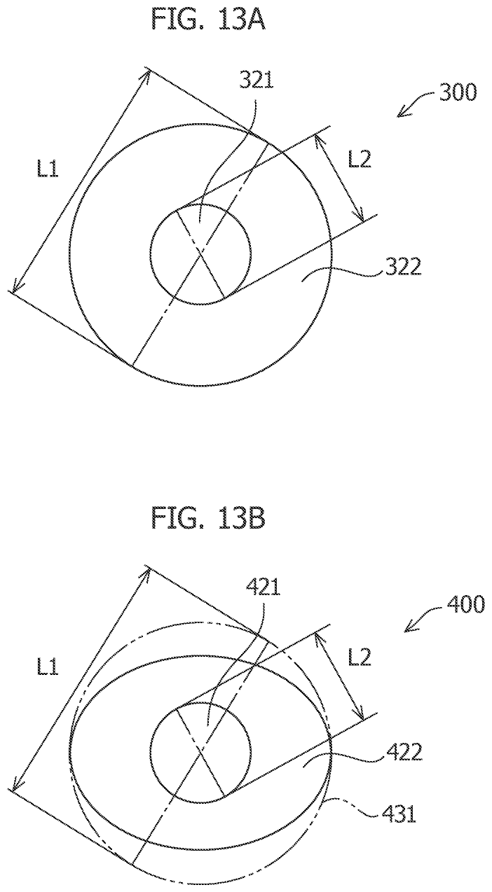

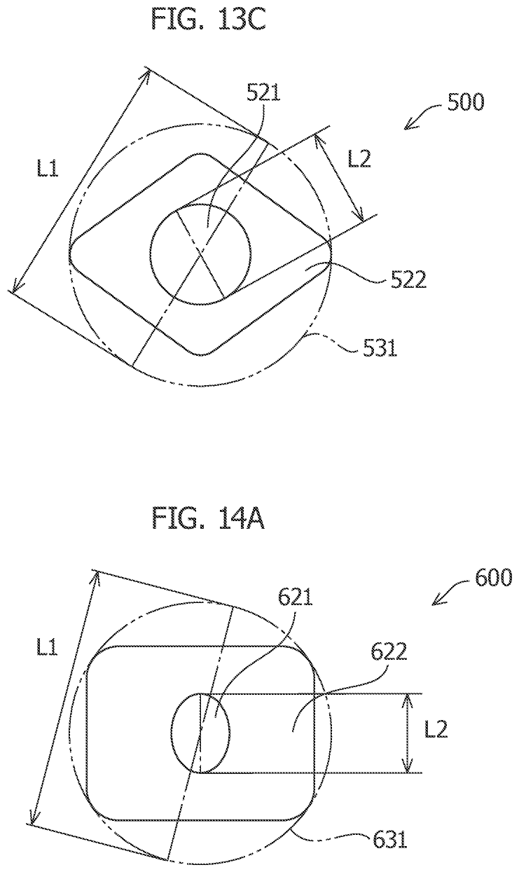

FIG. 13A to FIG. 13C are plan views of bimetals of which external forms are different from those of the bimetals according to the first and second embodiments.

As shown in FIG. 13A, a bimetal 300 has a circular shape in planar view and has a central portion 321 having a circular shape and an outer peripheral portion 322. A diameter length L2 of the central portion 321 is 1% to 50% of a diameter length L1 of the bimetal 300.

As shown in FIG. 13B, a bimetal 400 has an oval shape in planar view and has a central portion 421 having a circular shape and an outer peripheral portion 422. The diameter length L2 of the central portion 421 is 1% to 50% of the diameter length L1 of a circumcircle 431 circumscribed to an outer peripheral portion of the bimetal 400.

As shown in FIG. 13C, a bimetal 500 has a rhombus shape in planar view and has a central portion 521 having a circular shape and an outer peripheral portion 522. The diameter length L2 of the central portion 521 is 1% to 50% of the diameter length L1 of a circumcircle 531 circumscribed to an outer peripheral portion of the bimetal 500.

The cross-sectional shapes of the bimetals 300, 400, and 500 are similar to the cross-sectional shape of the bimetal 100 or 200. Effects similar to the above can also be obtained by the bimetals 300, 400, and 500.

### Fourth Embodiment

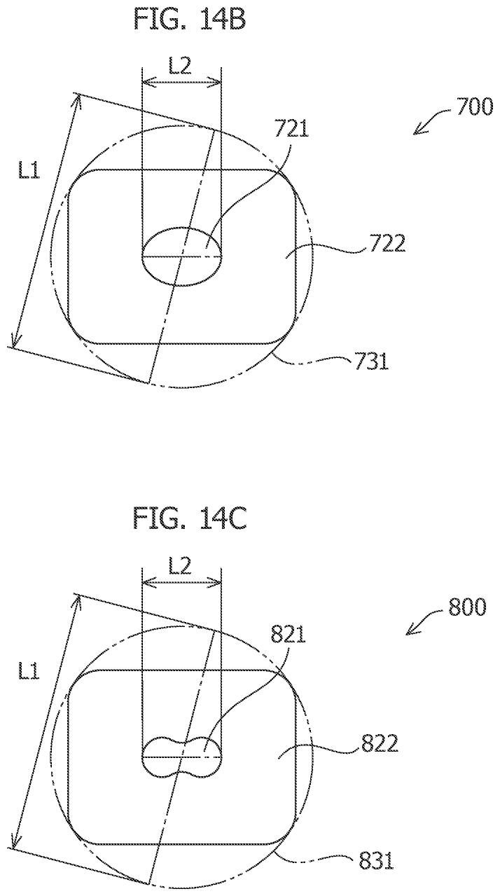

FIG. 14A to FIG. 14C are plan views of bimetals of which shapes of central portions are different from those of the bimetals according to the first and second embodiments.

As shown in FIG. 14A, a bimetal 600 has a quadrilateral shape in planar view and has a central portion 621 having an oval shape and an outer peripheral portion 622. A major axis of the central portion 621 extends in the width direction of the bimetal 600. The length L2 of the major axis is 1% to 50% of the diameter length L1 of a circumcircle 631 circumscribed to an outer peripheral portion of the bimetal 600. The center of the central portion 621 is the center of the circumcircle 631.

As shown in FIG. 14B, a bimetal 700 has a quadrilateral shape in planar view and has a central portion 721 having an oval shape and an outer peripheral portion 722. A major axis of the central portion 721 extends in the length direction of the bimetal 600. The length L2 of the major axis is 1% to 50% of the diameter length L1 of a circumcircle 731 circumscribed to an outer peripheral portion of the bimetal 700. The center of the central portion 721 is the center of the circumcircle 731.

As shown in FIG. 14C, a bimetal 800 has a quadrilateral shape in planar view and has a central portion 821 and an outer peripheral portion 822. The central portion 821 has a peanut shape (a shape constricted in the middle and swollen on both sides), and the longitudinal direction of the central portion 821 is parallel to the length direction of the bimetal 800. The length L2 of the central portion 821 is 1% to 50% of the diameter length L1 of a circumcircle 831 circumscribed to an outer peripheral portion of the bimetal 800. The center of the central portion 821 is the center of the circumcircle 831.

When the bimetals 600, 700, and 800 are manufactured, the shape of the protruding portion X of the punch P2 can be an oval shape or a peanut shape. The cross-sectional shapes of the bimetals 600, 700, and 800 are similar to the cross-sectional shape of the bimetal 100 or 200. Effects similar to the above can also be obtained by the bimetals 600, 700, and 800.

By setting the major axis of the oval shape or the peanut shape of the central portion to be the length direction or the width direction of the external form of the bimetal, the differential can be adjusted and the inversion height can be changed when the bimetal is inverted. By setting the major axis of the oval shape or the peanut shape of the central portion to be the width direction of the external form of the bimetal, the height of the bimetal after inversion becomes greater as compared to when the major axis is set to the length direction of the external form of the bimetal. The increased height of the bimetal after inversion can increase the height at which a movable plate with a movable contact is pushed up by the bimetal, for example, when the bimetal is used in a temperature switch, thereby increasing a breaking current capacity. As above, it becomes possible to create various bimetal inversion characteristics by causing the shape of the central portion to be shapes other than a circular shape.

### Fifth Embodiment

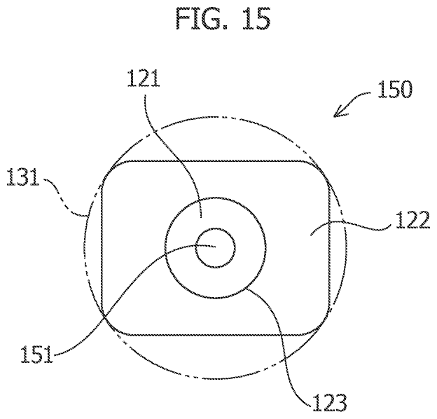

A bimetal 150 is shown in FIG. 15. The bimetal 150 is obtained by providing a hole portion 151 in the central portion 121 of the bimetal 100 according to the first embodiment. A hole portion may be provided in the central portion 221 of the bimetal 200 according to the second embodiment.

The hole portion may be used for the positioning and fixing of the bimetal when the bimetal is used in a temperature switch and the like. The hole portion is not limited to have a circular shape and may have an oval shape (not shown). However, it is preferred that the hole portion fit in the inner side of the border 123 between the central portion 121 and the outer peripheral portion 122 and the center of the hole portion be the same as the center of the circumcircle 131.

The formation of the hole portion may be performed before the pressing step or may be performed in the middle of the pressing step (between the first step and the second step) or after the step of the last stage.

Effects similar to the above can also be obtained by the bimetals as above.

The first embodiment and the second embodiment may be modified as appropriate and carried out by combining the external forms of the bimetals, the shapes of the central portion, and the hole portion described in the third embodiment to the fifth embodiment. The pressing step has been described to have a total of two steps, that is, the first step and the second step, but may have three or more steps. However, in the pressing process of the last stage, the bimetal is shaped by the punch having the protruding portion and the die having the planar surface portion. As a result, the effects described above can be obtained.

In the embodiments 1 and 2, the first step is performed after the bimetal material is cut. However, the pressing process of the first step may be performed at the same time as the cutting of the bimetal. Processes of hole punching, blanking, pressing, and cutting of the bimetal can be performed by using a progressive stamping.

The operating temperature and the return temperature can be adjusted by the temperature and the time of the thermal processing of the bimetal after the pressing process. The operating temperature and the return temperature can be increased by increasing the temperature and the time of the thermal processing.

### EXAMPLE

Next, with reference to Table 1, experiments performed to check the effects of the first to third embodiments and the fifth embodiment and results thereof are described. In all of the experiments, a press machine was used, the material of the punch was alloy tool steel, and urethane that is an elastic material was used as the material of the die. The pressing force in the first step and the second step was measured with use of a load cell (load converter). The operating temperature and the return temperature were measured by a method of detecting an impact of inversion of the bimetal by changing the temperature in a tank with an air-circulation-type bimetal temperature inspection apparatus. As described above, the temperature at which the shape in FIG. 3 is inverted to the shape in FIG. 2 or the shape in FIG. 9 is inverted to the shape in FIG. 10 in accordance with the rise in temperature was defined as the operating temperature, and the temperature at which the shape in FIG. 2 is inverted to the shape in FIG. 3 or the shape in FIG. 10 is inverted to the shape in FIG. 9 in accordance with the drop of temperature was defined as the return temperature. In the experiment, measurement was performed by changing the temperature in the tank at the increase rate of 1° C./1 minute for the operating temperature and at the decrease rate of 1° C./1 minute for the return temperature.

TABLE 1

| | | | | | Second step | | | | | | | |
|---|---|---|---|---|---|---|---|---|---|---|---|---|
| | | | First step | | | Diameter | | | Temperature characteristics | | | |
| | | | | Press- | | of convex | | Press- | Operating | Return | | |
| | | | Punch | ing | Punch | portion | | ing | temper- | temper- | Differ- | |
| | | External | side/ | force | side/ | of punch | | force | ature | ature | ential | |
| | | form | die side | (kgf) | die side | (L13) | | (kgf) | (° C.) | (° C.) | (deg) | Remarks |
| Example 1-1 | First | Rounded | Low | 101.0 | Low | 5 | mm | 100.7 | −3.3 | −17.2 | 13.9 | |
| Example 1-2 | embodiment | quadrilateral | expansion | 100.4 | expansion | | | 121.4 | −12.0 | −25.6 | 13.6 | |
| Example 1-3 | | shape (14 | layer/high | 101.6 | layer/high | | | 140.0 | −18.6 | −30.1 | 11.5 | |
| Example 1-4 | | mm × 10 | expansion | 101.1 | expansion | | | 157.2 | −21.4 | −32.3 | 10.9 | |
| | | mm) | layer | | layer | | | | | | | |
| Example 1-5 | | | High | 100.8 | | | | 120..2 | 14.2 | 1.9 | 12.3 | |
| | | | expansion | | | | | | | | | |
| | | | layer/low | | | | | | | | | |
| | | | expansion | | | | | | | | | |
| | | | layer | | | | | | | | | |
| Example 2-1 | | | Low | 105.8 | | 1.2 | mm | 53.3 | 16.0 | 9.6 | 6.4 | |
| Example 2-2 | | | expansion | 100.5 | | 3 | mm | 140.0 | −6.4 | −13.1 | 6.7 | |
| Example 2-3 | | | layer/high | 100.4 | | | | 143.6 | −8.5 | −14.3 | 5.8 | |
| Example 2-4 | | | expansion | 104.4 | | | | 151.5 | −12.4 | −16.9 | 4.5 | |
| Example 2-5 | | | layer | 101.2 | | 6.4 | mm | 82.5 | 15.3 | 5.7 | 9.6 | |
| Example 3 | Fifth | | | 101.7 | | 5 | mm | 143.7 | −14.4 | −26.5 | 12.1 | Hole having |
| | embodiment | | | | | | | | | | | diameter of |
| | | | | | | | | | | | | 2 mm |
| Example 4 | Third | Circular shape | | 100.2 | | | | 122.8 | −4.8 | −10.7 | 5.9 | |
| | embodiment | (diameter | | | | | | | | | | |
| | | 13 mm) | | | | | | | | | | |
| Example 5-1 | Second | Rounded | High | 101.7 | High | | | 102.2 | 98.1 | 89.1 | 9.0 | |
| Example 5-2 | embodiment | quadrilateral | expansion | 101.9 | expansion | | | 120.7 | 103.5 | 95.6 | 7.9 | |
| Example 5-3 | | shape (14 | layer/low | 102.9 | layer/low | | | 143.6 | 114.3 | 110.2 | 4.1 | |
| | | mm × 10 | expansion | | expansion | | | | | | | |
| | | mm) | layer | | layer | | | | | | | |
| Comparative | | Rounded | Low | 101.7 | Low | 7.6 | mm | 84.8 | — | — | — | Temperature |
| Example 1 | | quadrilateral | expansion | | expansion | | | | | | | characteristics |
| | | shape (14 | layer/high | | layer/high | | | | | | | are unmeasurable |
| | | mm × 10 | expansion | | expansion | | | | | | | |
| | | mm) | layer | | layer | | | | | | | |
| Comparative | | | | 101.6 | High | | | 102.2 | 66.2 | 29.9 | 36.3 | The punch in the |
| Example 2 | | | | | expansion | | | | | | | second step uses |
| | | | | | layer/low | | | | | | | the same punch |
| | | | | | expansion | | | | | | | with a curvature |
| | | | | | layer | | | | | | | radius of 24 mm |
| Comparative | | | High | 101.3 | Low | | | 100.2 | 62.0 | 26.5 | 35.5 | at the distal |
| Example 3 | | | expansion | | expansion | | | | | | | end as in the |
| | | | layer/low | | layer/high | | | | | | | first step |
| | | | expansion | | expansion | | | | | | | |
| | | | layer | | layer | | | | | | | |

### Example 1 (Corresponding to First Embodiment)

A bimetal (a low expansion layer was a Ni—Fe alloy and a high expansion layer was a Cu—Ni—Mn alloy) having a plate thickness of 0.15 mm was cut into the rounded quadrilateral shape shown in FIG. 1. The external form was 14 mm×10 mm, and the four angle portions had curved shapes each having a curvature radius of 3 mm. The diameter of the circumcircle of the bimetal was 14.9 mm. The bimetal and tools including a punch and a die were maintained at a temperature that was in the same range as room temperature.

As a first step, the bimetal was disposed on the die having a planar surface, the punch having a distal end with a curvature radius of 24 mm was lowered, and the bimetal was pressed for about one second with a force of about 100 kgf. At this time, the bimetal was placed such that the low expansion layer was on the punch side and the high expansion layer was on the die side, or the high expansion layer was on the punch side and the low expansion layer was on the die side.

Next, as a second step (a pressing step of the last stage), the bimetal shaped in the first step was disposed on the die having a planar surface, the punch having a convex portion was lowered, and the bimetal was pressed. At this time, the bimetal was placed such that the low expansion layer was on the punch side and the high expansion layer was on the die side. The shape of the convex portion was similar to the shape shown in FIG. 6, an end surface of the protruding portion X and the end surface Y were planar surfaces, the diameter length L13 of the end surface of the protruding portion X was 5 mm, the protruding amount H was 0.3 mm, and the diameter length L14 of the surface Y was 15 mm. The diameter length L13 (5 mm) was about 34% of the diameter of the circumcircle that was 14.9 mm. The pressing was performed for about one second, and thermal processing was performed for one hour at 200° C. after the pressing process.

In Table 1, a result of performing an experiment by changing the pressing force in the second step is shown as Examples 1-1 to 1-5. As shown in Table 1, the operating temperature and the return temperature were equal to or less than room temperature. As shown in Examples 1-1 to 1-4, the operating temperature and the return temperature decreased as the pressing force increased, and the operating temperature reached −21.4° C. and the return temperature reached −32.3° C., at the lowest. In all conditions, the differential was able to be as narrow as 10-19 degrees.

### Example 2 (Corresponding to First Embodiment)

Example 2 was performed under the same conditions as Example 1 except that the diameter length L13 of the convex portion of the punch used in the second step was set to 1.2 mm, 3 mm, or 6.4 mm and the pressing force was changed. The diameter length L13 of 1.2 mm, 3 mm, or 6.4 mm was about 8%, about 20%, or about 43% of the diameter of the circumcircle that was 14.9 mm. A result is shown in Table 1 as Examples 2-1 to 2-5. The temperature characteristics were able to be changed by the pressing force of the punch in the second step and the diameter length L13 of the convex portion. A differential of less than 10 degrees could be set by using the punch having the convex portion with the diameter of 1.2 mm, 3 mm, or 6.4 mm as above.

### Example 3 (Corresponding to Fifth Embodiment)

A result of performing an experiment similar to Example 1 by preparing a bimetal material with a hole having a diameter of 2 mm is similarly shown in Table 1 as Example 3. Even when the bimetal with a hole was used, a bimetal having temperature characteristics of an extremely low temperature and a narrow differential of 10-19 degrees was able to be manufactured.

### Example 4 (Corresponding to Third Embodiment)

The external form of the bimetal was a circular shape as shown in FIG. 13A, and the diameter was 13 mm. A result of an experiment performed under the same conditions as Example 1 other than the external form of the bimetal is similarly shown in Table 1 (Example 4). Even when the external form of the bimetal was a circular shape, a bimetal having temperature characteristics of an extremely low temperature and a differential of less than 10 degrees was able to be manufactured. The diameter length L13 of the end surface of the protruding portion X of the punch in the second step was 5 mm and was about 38% of the diameter of the external form of the bimetal that was 13 mm.

### Example 5 (Corresponding to Second Embodiment)

A bimetal material (a low expansion layer was a Ni—Fe alloy and a high expansion layer was a Cu—Ni—Mn alloy) having a plate thickness of 0.15 mm was cut into the rounded quadrilateral shape shown in FIG. 8. The external form was 14 mm×10 mm, and the four angle portions had curved shapes each having a curvature radius of 3 mm. The diameter of the circumcircle of the bimetal was 14.9 mm. The bimetal and the tools including the punch and the die were maintained at a temperature that was in the same range as room temperature.

As a first step, the bimetal material was disposed on the die having a planar surface, the punch having a distal end surface with a curvature radius of 24 mm was lowered, and the bimetal material was pressed for about one second with a force of about 100 kgf. At this time, the bimetal was placed such that the high expansion layer was on the punch side and the low expansion layer was on the die side.

Next, as a second step (a pressing step of the last stage), the bimetal shaped in the first step was disposed on the die having the planar surface, the punch having a protruding portion was lowered, and the bimetal was pressed. At this time, the bimetal was placed such that the high expansion layer was on the punch side and the low expansion layer was on the die side. The shape of the protruding portion was similar to the shape shown in FIG. 6, an end surface of the protruding portion X and the end surface Y were planar surfaces, the diameter length L13 of the end surface of the protruding portion X was 5 mm, the protruding amount H was 0.3 mm, and the diameter length L14 of the surface Y was 15 mm. The diameter length L13 (5 mm) was about 34% of the diameter of the circumcircle that was 14.9 mm. The pressing was performed for about one second, and thermal processing was performed for one hour at 200° C. after the pressing process.

In Table 1, a result of performing an experiment by changing the pressing force of the second step is shown as Examples 5-1 to 5-5. As shown in the result, the operating temperature and the return temperature were equal to or greater than room temperature, and the operating temperature and the return temperature increased in accordance with the pressing force of the punch in the second step, and the differential of less than 10 degrees was able to be obtained.

### Comparative Example 1

Example 2 was performed under the same conditions as Example 1 except that the diameter length L13 of the convex portion of the punch used in the second step was set to 7.6 mm and that the pressing force was changed. The diameter length L13 (7.6 mm) was about 51% of the diameter of the circumcircle that was 14.9 mm. The result is shown in Table 1 as Comparative Example 1. A bimetal manufactured under this condition was not inverted by a snap action, and the inversion temperature was not able to be measured by the bimetal temperature inspection apparatus. From the above, it was understood that inversion by a snap action does not occur when the convex portion of the punch (in other words, the border 123 of the bimetal) exceeds 50% of the diameter of the circumcircle.

### Comparative Examples 2 and 3

As the punch used in the second step, a punch having a distal end with a curvature radius of 24 mm that is the same as the punch used in the first step was used. In Comparative Example 2, the bimetal was placed such that the low expansion layer was on the punch side and the high expansion layer was on the die side in the first step, and the bimetal was placed such that the high expansion layer was on the punch side and the low expansion layer was on the die side in the second step. In Comparative Example 3, the bimetal was placed such that the high expansion layer was on the punch side and the low expansion layer was on the die side in the first step, and the bimetal was placed such that the low expansion layer was on the punch side and the high expansion layer was on the die side in the second step. The result of an experiment performed under the same conditions as Example 1, except for the above and changing the pressing force of the second step, is similarly shown in Table 1 (Comparative Examples 2, 3).

Even when the direction in which the bimetal was pressed was changed, the operating temperature and the return temperature did not change very much, and the differential exceeded 35 degrees. The cross-sectional structures at room temperature, when these bimetals were inverted at the return temperature or below, had curved shapes in which the low expansion layer is convex upward as in FIG. 3, but had single curves (not shown) and not compound curves. The cross-sectional structures inverted at the operating temperature or more had also single curves (not shown) and not compound curves. The bimetal having a cross-sectional structure formed by a single curve as above did not have the degree of freedom in setting the operating temperature, the return temperature, and the differential, and a relatively narrow differential setting of about 10 degrees was not able to be performed.

As above, according to embodiments of the present invention, it becomes possible to provide the thermally responsive element which is capable of freely setting the differential across a wide range of temperature zones and which has a relatively small differential that is about 10 degrees, the operating temperature and the return temperature that are extremely low temperatures equal to or below room temperature.

The embodiments described above are also applicable to thermally responsive elements other than the bimetal such as a shape memory alloy (100° C. or below) and tri-metal.

Following notes are disclosed regarding the embodiments described above.

### Supplementary Item 1

A thermally responsive element, the thermally responsive element which is a plate-like member and which has a shape that changes in accordance with a temperature change, in which:
a cross-section of the thermally responsive element at room temperature has a compound curved shape formed by combining a plurality of curves, a cross-section of a central portion of the thermally responsive element and a cross-section of an outer peripheral portion surrounding the central portion each having a different curved shape;
the shape of the thermally responsive element changes when a predetermined temperature out of a range of room temperature is reached;
a cross-section of the thermally responsive element after the shape change has a compound curved shape formed by combining a plurality of curves, a cross-section of the central portion of the thermally responsive element and a cross-section of the outer peripheral portion surrounding the central portion each having a different curved shape; and
a border between the central portion and the outer peripheral portion is the same before and after the shape change of the thermally responsive element.

### Supplementary Item 2

The thermally responsive element according to note 1, in which:
the thermally responsive element is a bimetal including:
   a first metal layer; and
   a second metal layer which is below the first metal layer and which has a greater coefficient of thermal expansion than the first metal layer;
the predetermined temperature is a temperature that falls below room temperature;
the thermally responsive element at room temperature has a shape which is convex downward as a whole with the central portion protruding downward; and
the thermally responsive element after the shape change has a shape which is convex upward as a whole with the central portion protruding upward.

### Supplementary Item 3

The thermally responsive element according to note 1, in which:
the thermally responsive element is a bimetal including:
   a first metal layer; and
   a second metal layer which is below the first metal layer and which has a greater coefficient of thermal expansion than the first metal layer;
the predetermined temperature is a temperature that exceeds room temperature;
the thermally responsive element at room temperature has a shape which is convex upward as a whole with the central portion protruding upward; and
the thermally responsive element after the shape change has a shape which is convex downward as a whole with the central portion protruding downward.

### Supplementary Item 4

The thermally responsive element according to any one of notes 1 to 3, in which:
the thermally responsive element has a rounded quadrilateral shape in plan view; and
the border is on a circumference of a concentric circle having a diameter of a length that is 1% to 50% of a diameter of a circumcircle circumscribed to the rounded quadrilateral shape.

### Supplementary Item 5

The thermally responsive element according to any one of notes 1 to 3, in which:
the thermally responsive element has a circular shape in plan view; and
the border is on a circumference of a concentric circle having a diameter of a length that is 1% to 50% of a diameter of the circular shape.

### Supplementary Item 6

A method of manufacturing a thermally responsive element according to any one of notes 1 to 5, the method including a step of shaping a material of the thermally responsive element by a multi-stage pressing process by a press machine, in which a punch which is made of metal and which has a shape with a central portion protruding and a die made of an elastic material are used in a pressing process of a last stage in the multi-stage pressing process.

### Supplementary Item 7

A method of manufacturing a thermally responsive element according to any one of notes 1 to 5, the method including a step of performing a pressing process during which a material of the thermally responsive element is sandwiched between upper and lower tools made of metal.

The embodiments of the present invention have been described above, but the present invention is not limited to the embodiments described above, and various types of modifications and changes can be made based on the technical idea of the present invention.

### REFERENCE SIGNS LIST

100, 150, 200, 300, 400, 500, 600, 700, 800 bimetal
111, 211 low expansion layer
112, 212 high expansion layer
121, 221 central portion
122, 222 outer peripheral portion
123, 223 border
131, 231 circumcircle
151 hole portion
L1, L11, L21 length
L2, L12, L22 length
P1, P2 punch
D die

1. A thermally responsive element, the thermally responsive element which is a plate-like member and which has a shape that changes in accordance with a temperature change, wherein:
a cross-section of the thermally responsive element at room temperature has a compound curved shape formed by combining a plurality of curves, a cross-section of a central portion of the thermally responsive element and a cross-section of an outer peripheral portion surrounding the central portion each having a different curved shape;
the shape of the thermally responsive element changes when a predetermined temperature out of a range of room temperature is reached;
a cross-section of the thermally responsive element after the shape change has a compound curved shape formed by combining a plurality of curves, a cross-section of the central portion of the thermally responsive element and a cross-section of the outer peripheral portion surrounding the central portion each having a different curved shape; and
a border between the central portion and the outer peripheral portion is the same before and after the shape change of the thermally responsive element.

2. The thermally responsive element according to claim 1, wherein:
the thermally responsive element is a bimetal including:
a first metal layer; and
a second metal layer which is below the first metal layer and which has a greater coefficient of thermal expansion than the first metal layer;
the predetermined temperature is a temperature that falls below room temperature;
the thermally responsive element at room temperature has a shape which is convex downward as a whole with the central portion protruding downward; and
the thermally responsive element after the shape change has a shape which is convex upward as a whole with the central portion protruding upward.

3. The thermally responsive element according to claim 1, wherein:
the thermally responsive element is a bimetal including:
a first metal layer; and
a second metal layer which is below the first metal layer and which has a greater coefficient of thermal expansion than the first metal layer;
the predetermined temperature is a temperature that exceeds room temperature;
the thermally responsive element at room temperature has a shape which is convex upward as a whole with the central portion protruding upward; and
the thermally responsive element after the shape change has a shape which is convex downward as a whole with the central portion protruding downward.

4. The thermally responsive element of claim 1, wherein:
the thermally responsive element has a rounded quadrilateral shape in plan view; and
the border is on a circumference of a concentric circle having a diameter of a length that is 1% to 50% of a diameter of a circumcircle circumscribed around the rounded quadrilateral shape.

5. The thermally responsive element of claim 1, wherein:
the thermally responsive element has a circular shape in plan view; and
the border is on a circumference of a concentric circle having a diameter of a length that is 1% to 50% of a diameter of the circular shape.

6. A method of manufacturing the thermally responsive element of claim 1, the method comprising a step of shaping a material of the thermally responsive element by a multi-stage pressing process by a press machine, wherein a punch which is made of metal and which has a shape with a central portion protruding and a die made of an elastic material are used in a pressing process of a last stage in the multi-stage pressing process.

7. A method of manufacturing the thermally responsive element of claim 1, the method comprising a step of performing a pressing process during which a material of the thermally responsive element is sandwiched between upper and lower tools made of metal.
